(19) United States
(12) Patent Application Publication
(10) Pub. No.: US 2015/0207361 A1
(43) Pub. Date: Jul. 23, 2015

(54) METHOD AND APPARATUS FOR CHANGING OPERATION STATUS OF ELECTRONIC DEVICE

(71) Applicant: INDUSTRY-UNIVERSITY COOPERATION FOUNDATION HANYANG UNIVERSITY, Seoul (KR)

(72) Inventors: SangHyuk JUNG, Seoul (KR); Yong Ho SONG, Seongnam (KR)

(73) Assignee: INDUSTRY-UNIVERSITY COOPERATION FOUNDATION HANYANG UNIVERSITY, Seoul (KR)

(21) Appl. No.: 14/281,801

(22) Filed: May 19, 2014

(30) Foreign Application Priority Data
Jan. 22, 2014 (KR) 10-2014-0008013

(51) Int. Cl. H02J 9/06; G06F 1/26

(52) U.S. Cl. CPC H02J 9/061; G06F 1/263

(57) ABSTRACT

An apparatus and method for changing an operation status of an electronic device using an embedded battery is provided. The apparatus and method for changing the operation status of the electronic device may detect an event that requires a change in the operation status of the electronic device, may switch a battery used for an operation of the electronic device from a first battery detachable from the electronic device to a second battery embedded in the electronic device, in response to detecting the event, and may change the operation status of the electronic device by employing the second battery as a power source.

### CROSS-REFERENCE TO RELATED APPLICATION

This application claims the priority benefit of Korean Patent Application No. 10-2014-0008013, filed on Jan. 22, 2014, in the Korean Intellectual Property Office, the disclosure of which is incorporated herein by reference.

### BACKGROUND

1. Field of the Invention

Embodiments relate to a method of changing an operation status of an electronic device, and more particularly, to a method of changing an operation status of an electronic device embedded with a battery and the electronic device.

2. Description of the Related Art

Portable electronic devices that use a battery as a power source, such as digital cameras, portable music players, mobile phones, personal digital assistants (PDAs), tablets, and notebooks, are being widely used. Such an electronic device essentially employs a battery as a power source and thus, cannot supply power to a system when the battery is separated from the electronic device. When the power is not supplied, data about a task being performed by the electronic device may be lost.

A data backup operation may be performed periodically to overcome the above issue. However, a periodic backup may aggravate the system for additional processing. Also, such addition processing may lead to a power consumption of the battery.

### SUMMARY

Embodiments may provide an apparatus and method for changing an operation status of an electronic device.

Embodiments may also provide an apparatus and method for changing an operation status of an electronic device using an embedded battery in response to detecting an event that requires a change in the operation status of the electronic device.

According to an aspect of embodiments, there is provided a method of changing an operation status of an electronic device, performed by the electronic device, the method including: detecting an event that requires a change in the operation status of the electronic device; switching a battery used for an operation of the electronic device from a first battery detachable from the electronic device to a second battery embedded in the electronic device, in response to detecting the event; and changing the operation status of the electronic device by employing the second battery as a power source.

The event may be a request for terminating the operation of the electronic device from a user of the electronic device.

The event may be a circumstance in which an amount of power capable of being supplied from the first battery is less than a predetermined amount.

The event may be a circumstance in which the first battery is separated from the electronic device.

The event may be a circumstance in which a normal operation of the electronic device is disabled due to a malfunction of the electronic device.

The changing of the operation status may include switching the operation status of the electronic device to a power saving mode for maintaining data of a volatile memory of the electronic device.

The operation status changing method may further include switching the operation status of the electronic device from the power saving mode to a normal mode when the power source configured to supply at least a predetermined amount of power is attached to the electronic device.

The data may include data about a task that is performed by the electronic device when detecting the event.

The changing of the operation status may include changing the operational status of the electronic device by terminating the electronic device.

The operation status changing method may further include storing data of a volatile memory of the electronic device in a non-volatile memory of the electronic device by employing the second battery as the power source, when the battery used for the operation of the electronic device is switched from the first battery to the second battery.

A capacity of the second battery may be determined to be greater than a minimum amount of power required to store the data in the non-volatile memory.

The changing of the operation status may include changing the operation status of the electronic device by terminating the electronic device when storing the data of the volatile memory in the non-volatile memory is completed.

The operation status changing method may further include: detecting an attachment of the power source configured to supply at least a predetermined amount of power; transmitting the data stored in the non-volatile memory to the volatile memory by employing the attached power source when an amount of power supplied from the attached power source is greater than or equal to a predetermined amount; and restoring a task based on the transmitted data.

The operation status changing method may further include detecting an attachment of the power source configured to supply at least a predetermined amount of power; and charging the second battery using the attached power source.

The storing of the data may include storing the data of the volatile memory in a predetermined area of the non-volatile memory.

The predetermined area may be reserved to store the data of the volatile memory in the non-volatile memory.

A capacity of the predetermined area may be less than a maximum amount of data transmittable using a capacity of the second battery.

The data stored in the non-volatile memory may be stored in a form of a snap shot.

The operation status changing method may further include: detecting an attachment of the power source configured to supply at least a predetermined amount of power; determining whether an amount of power supplied from the attached power source is greater than or equal to a predetermined amount; switching the battery used for the operation of the electronic device from the second battery to the attached power source when the amount of power supplied from the attached power source is greater than or equal to the predetermined amount; and changing again the operation status of the electronic device using the attached power source.

The operation status changing method may further include outputting an alarm for notifying detection of the event using a speaker or a display of the electronic device, in response to detecting the event.

According to another aspect of embodiments, there is provided an electronic device, including: a processing unit configured to detect an event that requires a change in an operation status of the electronic device, and to switch a battery used for an operation of the electronic device from a first battery detachable from the electronic device to a second battery, in response to detecting the event, and to change the operation status of the electronic device by employing the second battery as a power source; and the second battery embedded in the electronic device.

According to still another aspect of embodiments, there is provided an electronic device, including: a first battery detachable from the electronic device and configured to supply power to the electronic device; a second battery embedded in the electronic device and unused to boot the electronic device; and a processing unit configured to detect an event that requires a change in an operation status of the electronic device and to change an operation status of the electronic device using power of the second battery instead of using the first battery, in response to detecting the event.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a configuration of an electronic device according to an embodiment.

FIG. 2 is a flowchart illustrating a method of changing an operation status of an electronic device according to an embodiment.

FIG. 3 is a flowchart illustrating a method of changing again an operation status of an electronic device when a power source is attached according to an embodiment.

FIG. 4 is a flowchart illustrating a method of protecting data of a volatile memory according to an embodiment.

FIG. 5 is a diagram describing a capacity of a predetermined area of a non-volatile memory according to an embodiment.

### DETAILED DESCRIPTION

Reference will now be made in detail to exemplary embodiments of the present invention, examples of which are illustrated in the accompanying drawings, wherein like reference numerals refer to like elements throughout. Exemplary embodiments are described below to explain the present invention by referring to the figures.

Various modifications may be made to embodiments and various embodiments may be provided. A few embodiments are illustrated in the drawings and are described in the detailed description. However, the embodiments are not to be limiting of the invention and thus, should be understood to include all the changes, modifications, equivalents, and substitutes included in the spirit and technical scope of the invention.

Terms used herein are used to simply describe the embodiments and are not used to be limiting of the embodiments. Unless clearly differently described in the context, a singular expression may include a plural expression. The term “comprises/includes” or “has” used herein are to designate the presence of a feature, a number, a step, an operation, a constituent element, and a part used herein, or a combination thereof and thus, should not be understood to exclude the presence or addition of at least one feature, number, step, operation, constituent element, and part, or a combination thereof.

Unless differently defined, all the terms used herein, including technical or scientific terms have the same meaning as the meaning generally understood by those skilled in the art. Terms defined in a generally used dictionary should be understood to have the meaning matching the contextual meaning the art and should not be idealistically or excessively formal meaning unless clearly defined herein.

Also, when describing the present specification with reference to the accompanying drawings, like reference numerals refer to like constituent elements throughout the present specification and a repeated description related hereto is omitted. When it is determined that a detailed description related to a related known art may make the purpose of the embodiments unnecessarily ambiguous in describing the embodiments, the detailed description will be omitted herein.

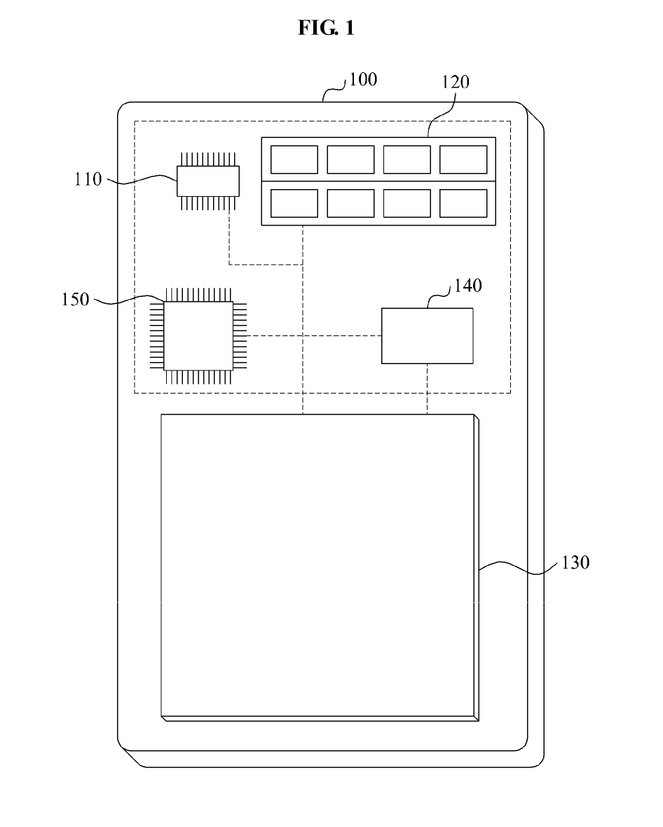

FIG. 1 is a diagram illustrating a configuration of an electronic device 100 according to an embodiment.

Referring to FIG. 1, the electronic device 100 may refer to a device using a battery. The electronic device 100 may refer to a mobile device, for example, an electronic clock, a mobile phone, a tablet, and a notebook.

The electronic device 100 may include a volatile memory 110, a non-volatile memory 120, a first battery 130, a second battery 140, and a processing unit 150.

The volatile memory 110 may be random access memory (RAM). The RAM may include dynamic RAM (DRAM) and static RAM (SRAM).

The non-volatile memory 120 may include at least one of a hard disk drive (HDD), a solid state disk (SSD), and a flash memory.

The flash memory may be a mobile negative AND (NAND) flash. The mobile NAND flash may include all of a NAND flash memory and a multimedia card controller.

The first battery 130 may be a battery detachable from the electronic device 100. For example, the first battery 130 may be a replaceable battery. The first battery 130 may be detachable from the electronic device 100 and may supply power to the electronic device 100.

Although an operation system (OS) of a system configured to drive the electronic device 100 consumes a large amount of power of a battery, the first battery 130 may be replaceable and thus, an issue that may occur due to the battery consumption of the electronic device 100 may be solved.

The second battery 140 may be a battery embedded in the electronic device 100. For example, typically, the second battery 140 may be neither detachable nor replaceable and predetermined processing such as disassemble of the electronic device 100 may be required for attaching/detaching or replacing the second battery 140.

The second battery 140 is provided in an embedded type and thus, sudden suspension of power supply from the second battery 140 to the electronic device 100 due to separation of the second battery 140 may not occur. Accordingly, a task being performed by the electronic device 100 may be protected through stable power supply.

An electronic device not embedded with a battery may need to periodically sore data required to be stored and relevant meta information in a nonvolatile memory from a volatile memory, in order to prepare for the sudden suspension of the power supply. A host OS, for example, ANDROID, of the electronic device not embedded with the battery may permanently store temporally stored data using a command called a flush command. When rebooting a system after sudden power-off, the electronic device not embedded with the battery may restore the system by gathering meta information scattered within a memory of the electronic device.

In contrast, the electronic device 100 embedded with the second battery 140 may have no need to back up data periodically to protect a task being performed, since the occurrence of sudden suspension of power supply is excluded. Since the electronic device 100 does not perform data backup periodically, tasks to be added to a system may decrease. Due to such a decrease in the tasks to be added to the system, the power of the electronic device 100 may be effectively used.

A capacity of a battery may depend on a size of the battery. Greater constraints may to be applied to a part embedded in the electronic device 100. Accordingly, a size of the second battery 140 may be greatly limited and a capacity of the first battery 130 may be greater than a capacity of the second battery 140.

The processing unit 150 may be a processor or a central processing unit (CPU). For example, the processing unit 150 may be a mobile processor of a mobile device. The operation status of the electronic device 100 may be changed by a power source configured to supply power to the electronic device 100. For example, when an amount of power to be supplied is insufficient, the electronic device 100 may be changed from a general operation status to an operation status that requires low power consumption.

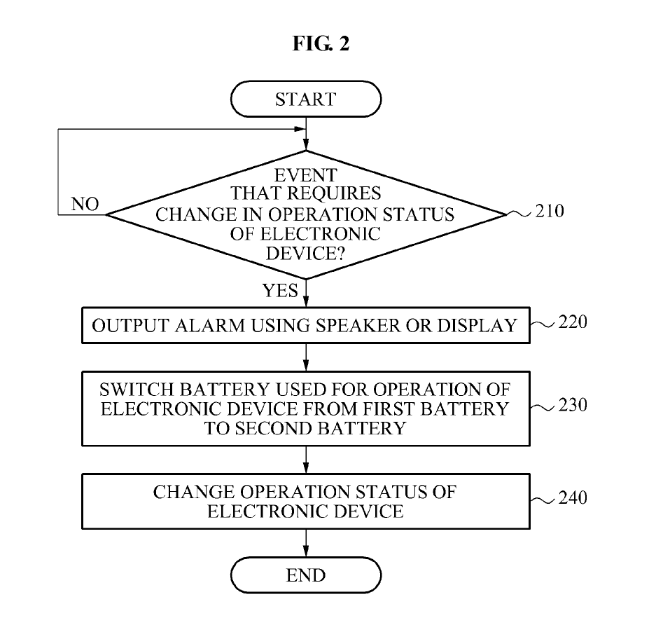

Hereinafter, a method of changing, by the electronic device 100, the operation status of the electronic device 100 using the second battery 140 will be described with reference to FIGS. 2 through 5.

FIG. 2 is a flowchart illustrating a method of changing an operation status of an electronic device according to an embodiment. The operation status changing method according to the present embodiment may be performed by the electronic device 100 of FIG. 1 or constituent elements of the electronic device 100.

In operation 210, the processing unit 150 may detect an event that requires a change in the operation status of the electronic device 100. Hereafter, the event that requires a change in the operation status of the electronic device 100 is referred to as an event.

For example, prior to commencing operation 210, the operation status of the electronic device 100 may be in a normal mode or a general mode in which the electronic device 100 operates a system using power of the first battery 130. For example, prior to commencing operation 210, the electronic device 100 may operate the system in a normal mode by employing the first battery 130 as a power source. Accordingly, the event may be an event that requires changing the operation status of the electronic device 100 from the normal mode to a different mode.

The processing unit 150 may detect the event and may change the operation status of the electronic device 100 using power of the second battery 140 instead of using the first battery 130, in response to detecting the event.

According to an embodiment, the event may be a request for terminating the operation of the electronic device 100 from a user of the electronic device 100. Terminating the operation of the electronic device 100 may be terminating the system of the electronic device 100.

According to an embodiment, the event may be a circumstance in which an amount of power capable of being supplied from the first battery 130 is less than a predetermined amount. The processing unit 150 may determine whether an amount of power capable of being supplied from the first 130 is less than the predetermined amount by continuously or periodically measuring an amount of power remaining in the first battery 130.

Further, an amount of power capable of being supplied from the first battery 130 may be an amount of power charged to the first battery 130.

For example, the predetermined amount may be an amount of minimum power used to maintain the operation status of the electronic device 100. When all the power charged to first battery 130 is consumed, the processing unit 150 may determine that an amount of power capable of being supplied form the first battery 130 is less than the predetermined amount.

According to an embodiment, the event may be a circumstance in which the first battery 130 is separated from the electronic device 100.

According to an embodiment, the event may be a circumstance in which a normal operation of the electronic device 100 is disabled due to a malfunction of the electronic device 100.

In operation 220, the processing unit 150 may output an alarm for notifying detection of the event, in response to detecting the event.

In response to the detected event, the processing unit 150 may output a different alarm.

For example, the processing unit 150 may output, using a speaker, a sound for notifying the user of the electronic device 100 that the power of the first battery 130 is used up.

As another example, the processing unit 150 may display, on a display, a screen for notifying the user of the electronic device 100 that the power of the first battery 130 is used up.

Operation 220 may not be performed. In this case, operation 230 may be performed.

In operation 230, the processing unit 150 may switch a battery used for the operation of the electronic device 100 from the first battery 130 detachable from the electronic device 100 to the second battery 140 embedded in the electronic device 100, in response to detecting the event.

The processing unit 150 may maintain a system or a task of the electronic device 100 using the power charged to the second battery 140.

For example, the task may include at least one of an execution of a program installed in the electronic device 100 and an execution of an application installed in the electronic device 100.

In operation 240, the processing unit 150 may change the operation status of the electronic device 100 by employing the second battery 140 as a power source.

According to an embodiment, the changed operation status of the electronic device 100 may be a status in which the electronic device 100 is terminated. The processing unit 150 may terminate the electronic device 100 through a normal termination procedure. For example, the processing unit 150 may change the operation status of the electronic device 100 by terminating the electronic device 100.

According to an embodiment, changing the operation status of the electronic device 100 may indicate switching the operation status of the electronic device 100 to a power saving mode for maintaining data of the volatile memory 110 of the electronic device 100. That is, the processing unit 150 may change the operation status of the electronic device 100 by changing the electronic device 100 to be in the power saving mode.

The power saving mode may refer to an operation status in which supply of power to the electronic device 100 is not completely suspended, however, an amount of power is insufficient to operate the system of the electronic device 100. For example, the power saving mode may refer to an operation status in which a relatively small amount of power is supplied compared to an amount of power required to maintain a normal mode. The power saving mode may refer to an operation status for preparing the system restore when a sufficient amount of power to operate the system is supplied.

The power saving mode may be cancelled when a power source configured to supply at least an amount of power is attached to the electronic device 100.

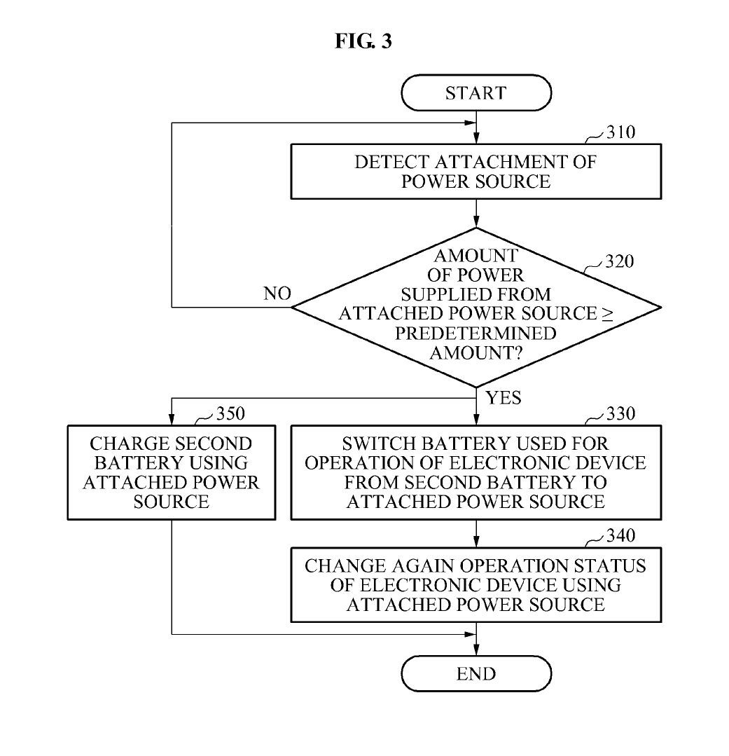

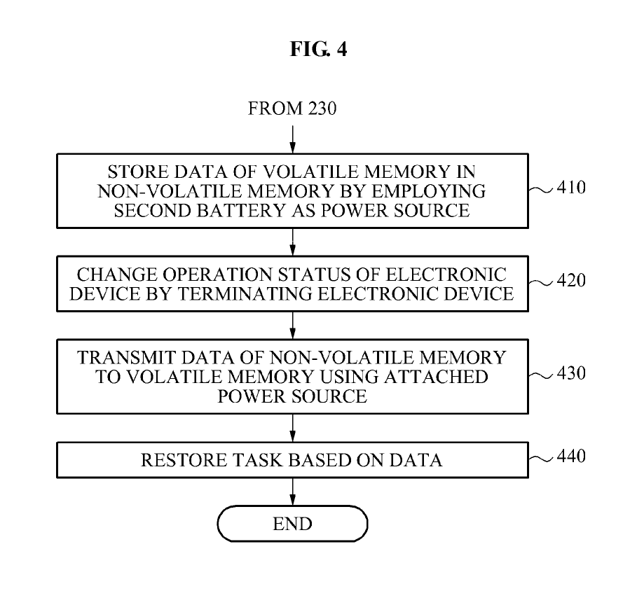

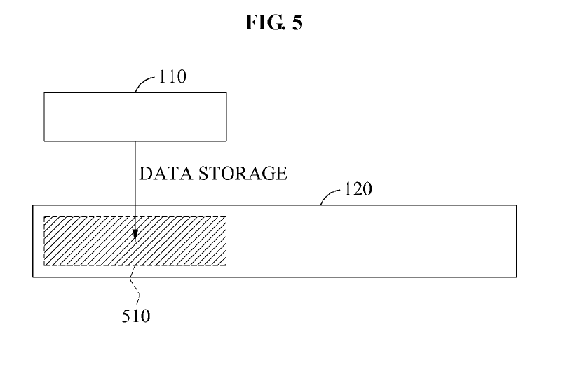

Data of the volatile memory 110 will be described with reference to FIGS. 4 and 5. The method of changing the operation status of the electronic device 100 using the second battery 140 may be described with reference to operations 210 through 240. Hereinafter, a method of changing again the changed operation status of the electronic device 100 will be described with reference to FIG. 3.

Technical description made with reference to FIG. 1 may be applicable as is and thus, further detailed description will be omitted.

FIG. 3 is a flowchart illustrating a method of changing again an operation status of the electronic device 100 when a power source is attached according to an embodiment. Operations 310 and 320 may be performed subsequent to operation 240 of FIG. 2. Similarly, the operation status changing method according to the present embodiment may be performed by the electronic device 100 of FIG. 1 or constituent elements of the electronic device 100.

In operation 310, the processing unit 150 may detect an attachment of a power source.

According to an embodiment, the attached power source may be a third battery. The third battery may refer to a battery attached to the electronic device 100 in lieu of the first battery 130. For example, the third battery may be a battery detachable from the electronic device 100 in lieu of the first battery 130.

According to an embodiment, the attached power source may refer to a power supply device. The power may be supplied to the electronic device 100 from not the battery but the power supply device using a cable or an adaptor.

In operation 320, the processing unit 150 may determine whether an amount of power supplied from the attached power source is greater than or equal to a predetermined amount.

For example, the processing unit 150 may determine whether an amount of power supplied from the third battery is greater than or equal to the predetermined amount.

According to an embodiment, when the power source configured to supply at least a predetermined amount of power is attached to the electronic device 100, the processing unit 150 may switch the operation status of the electronic device 100 from a power saving mode to a normal mode.

In operation 330, when an amount of power supplied from the attached power source is greater than or equal to the predetermined amount, the processing unit 150 may switch the battery used for the operation of the electronic device 100 from the second battery 140 to the attached power source.

In operation 340, the processing unit 150 may change again the operation status of the electronic device 100 using the attached power source.

According to an embodiment, changing gain the operation status of the electronic device 100 may indicate executing again the terminated operation of the electronic device 100. For example, executing again the operation may indicate booting the system of the electronic device 100.

According to an embodiment, changing again the operation status of the electronic device 100 may indicate changing the operation status of the electronic device 100 from the power saving mode to the normal mode.

Operation 350 may be performed when an amount of power supplied from the attached power source is greater than or equal to the predetermined amount. In operation 350, the processing unit 150 may charge the second battery 140 using the attached power source.

Operations 350 and 330 may be performed in parallel.

According to an embodiment, as described above, the second battery 140 may be embedded in the electronic device 100, and a size of the second battery 140 may be limited. Also, a capacity of the second battery 140 may be limited due to limitation of the size.

According to an embodiment, a capacity of the second battery 140 may be an amount of power used to be capable of carrying out the aforementioned operation status change. In detail, the capacity of the second battery 140 may be determined as a sufficient amount of power to change the operation status of the electronic device 100. For example, the capacity of the second battery 140 may be an amount of power capable of performing at least one of terminating a system of the electronic device 100, maintaining the power saving mode during a predetermined period of time, and backing up data of the volatile memory 110.

As another example, the second battery 140 may be used only to change the operation status of the electronic device 100. In detail, the second battery 140 may not be used to maintain or operate the normal mode of the electronic device 100. Also, when the system of the electronic device 100 is terminated, the second battery 140 may not be used to boot or start the electronic device 100.

Technical description made with reference to FIG. 1 may be applicable as is and thus, further detailed description will be omitted.

FIG. 4 is a flowchart illustrating a method of protecting data of a volatile memory according to an embodiment.

Operations 410 through 440 may be performed subsequent to operation 230 of FIG. 2. Similarly, the operation status changing method according to the present embodiment may be performed by the electronic device 100 of FIG. 1 or constituent elements of the electronic device 100.

In operation 410, when a battery used for an operation of the electronic device 100 is switched to the second battery 140, the processing unit 150 may store data of the volatile memory 110 of the electronic device 100 in the non-volatile memory 120 of the electronic device 100 by employing the second battery 140 as a power source. Storing data of the volatile memory 110 in the non-volatile memory 120 may indicate data backup. Data of the volatile memory 110 may include data about a task performed by the electronic device 100 in response to detecting the event in operation 210. For example, the data may include one of input data, output data, and processing data used to perform the task.

Also, data of the volatile memory 110 may be associated with the operation status of the electronic device 100. For example, the data may be used to change or change again the operation status of the electronic device 100.

Data stored in the non-volatile memory 120 may be stored in a form of a snap shot of the volatile memory 110.

According to an embodiment, a sufficient amount of power to store data of the volatile memory 110 in the non-volatile memory 120 may need to be supplied. Accordingly, a capacity of the second battery 140 may be determined to be greater than a minimum amount of power required to store data of the volatile memory 110 in the non-volatile memory 120.

In detail, when another power source excluding the second battery 140 is not provided to the electronic device 100, the capacity of the second battery 140 may be greater than an amount of power required to store the operation status of the electronic device 100.

The processing unit 150 may store data in a predetermined area of the non-volatile memory 120. The predetermined area is described in the following with reference to FIG. 5.

The processing unit 150 may store data of the volatile memory 110 in the non-volatile memory 120 using the second battery 140. Thus, the data may be protected although power supply to the electronic device 100 is suspended.

Operation 420 may correspond to operation 240 of FIG. 2 and thus, the description of operation 240 may be applied to operation 420.

In operation 420, when storing data in the non-volatile memory 120 is completed, the processing unit 150 may change the operation status of the electronic device 100 by terminating the electronic device 100.

For example, termination of the electronic device 100 may indicate an operation status in which power supply to the electronic device 100 is suspended.

According to an embodiment, operation 430 may be performed subsequent to operation 420.

According to an embodiment, when operation 420 is performed, operations 310 through 340 of FIG. 3 may be performed. When operation 340 is performed, operation 430 may be performed.

In operation 430, when an amount of power supplied from the attached power source is greater than or equal to a predetermined amount, the processing unit 150 may transmit the data stored in the non-volatile memory 120 to the volatile memory 110 using the attached power source.

In operation 440, the processing 150 may restore the task based on data stored in the volatile memory 110.

For example, the processing unit 150 may restore the task being performed when detecting the event.

Technical description made with reference to FIGS. 1 through 3 may be applicable as is and thus, further detailed description will be omitted.

FIG. 5 is a diagram describing a capacity of a predetermined area of a non-volatile memory according to an embodiment.

In operation 240 of FIG. 2, the processing unit 150 may store data of the volatile memory 110 in a predetermined area 510 of the non-volatile memory 120.

Depending on embodiments, the predetermined area 510 may be reserved to store the data of the volatile memory 110 in the non-volatile memory 120.

According to an embodiment, a capacity of the predetermined area 510 may be set based on a capacity of the second battery 140. For example, the capacity of the predetermined 510 may be less than a maximum amount of data transmittable using the capacity of the second battery 140. The second battery 140 is used to transmit the data and thus, when the capacity of the second battery 140 is insufficient, only a portion of the predetermined area 510 may be used to store data in practice although the predetermined area 510 has a large capacity.

According to an embodiment, the capacity of the predetermined area 510 may be greater than or equal to the capacity of the volatile memory 110.

The predetermined area 510 may have a capacity corresponding to an addition of the capacity of the volatile memory 110 and an amount of power used to store a current operation status of the electronic device 100.

Technical description made with reference to FIGS. 1 through 4 may be applicable as is and thus, further detailed description will be omitted.

According to embodiments, there may be provided an apparatus and method for changing an operation status of an electronic device.

Also, according to embodiments, there may be provided an apparatus and method for changing an operation status of an electronic device using an embedded battery in response to detecting an event that requires a change in the operation status of the electronic device.

Also, according to embodiments, there may be provided an apparatus and method for restoring a task of an electronic device when a power source is attached.

The units described herein may be implemented using hardware components, software components, or a combination thereof. For example, a processing device may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will be appreciated that a processing device may include multiple processing elements and multiple types of processing elements. For example, a processing device may include multiple processors or a processor and a controller. In addition, different processing configurations are possible, such as parallel processors.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A method of changing an operation status of an electronic device, performed by the electronic device, the method comprising:
detecting an event that requires a change in the operation status of the electronic device;
switching a battery used for an operation of the electronic device from a first battery detachable from the electronic device to a second battery embedded in the electronic device, in response to detecting the event; and
changing the operation status of the electronic device by employing the second battery as a power source.

2. The method of claim 1, wherein the event is a request for terminating the operation of the electronic device from a user of the electronic device.

3. The method of claim 1, wherein the event is a circumstance in which an amount of power capable of being supplied from the first battery is less than a predetermined amount.

4. The method of claim 1, wherein the event is a circumstance in which the first battery is separated from the electronic device.

5. The method of claim 1, wherein the event is a circumstance in which a normal operation of the electronic device is disabled due to a malfunction of the electronic device.

6. The method of claim 1, wherein the changing of the operation status comprises switching the operation status of the electronic device to a power saving mode for maintaining data of a volatile memory of the electronic device, and the method further comprises:
switching the operation status of the electronic device from the power saving mode to a normal mode when the power source configured to supply at least a predetermined amount of power is attached to the electronic device.

7. The method of claim 6, wherein the data comprises data about a task that is performed by the electronic device when detecting the event.

8. The method of claim 1, wherein the changing of the operation status comprises changing the operational status of the electronic device by terminating the electronic device.

9. The method of claim 1, further comprising:
storing data of a volatile memory of the electronic device in a non-volatile memory of the electronic device by employing the second battery as the power source, when the battery used for the operation of the electronic device is switched from the first battery to the second battery.

10. The method of claim 9, wherein a capacity of the second battery is determined to be greater than a minimum amount of power required to store the data in the non-volatile memory.

11. The method of claim 9, wherein the changing of the operation status comprises changing the operation status of the electronic device by terminating the electronic device when storing the data of the volatile memory in the non-volatile memory is completed.

12. The method of claim 11, further comprising:
detecting an attachment of the power source configured to supply at least a predetermined amount of power;
transmitting the data stored in the non-volatile memory to the volatile memory by employing the attached power source when an amount of power supplied from the attached power source is greater than or equal to a predetermined amount; and
restoring a task based on the transmitted data.

13. The method of claim 11, further comprising:
detecting an attachment of the power source configured to supply at least a predetermined amount of power; and
charging the second battery using the attached power source.

14. The method of claim 9, wherein the storing of the data comprises storing the data of the volatile memory in a predetermined area of the non-volatile memory, and
the predetermined area is reserved to store the data of the volatile memory in the non-volatile memory.

15. The method of claim 14, wherein a capacity of the predetermined area is less than a maximum amount of data transmittable using a capacity of the second battery.

16. The method of claim 9, wherein the data stored in the non-volatile memory is stored in a form of a snap shot.

17. The method of claim 1, further comprising:
detecting an attachment of the power source configured to supply at least a predetermined amount of power;
determining whether an amount of power supplied from the attached power source is greater than or equal to a predetermined amount;
switching the battery used for the operation of the electronic device from the second battery to the attached power source when the amount of power supplied from the attached power source is greater than or equal to the predetermined amount; and
changing again the operation status of the electronic device using the attached power source.

18. A non-transitory computer-readable storage medium storing a program to implement the method of claim 1.

19. An electronic device, comprising:
a processing unit configured to detect an event that requires a change in an operation status of the electronic device, and to switch a battery used for an operation of the electronic device from a first battery detachable from the electronic device to a second battery, in response to detecting the event, and to change the operation status of the electronic device by employing the second battery as a power source; and
the second battery embedded in the electronic device.

20. An electronic device, comprising:
a first battery detachable from the electronic device and configured to supply power to the electronic device;
a second battery embedded in the electronic device and unused to boot the electronic device; and
a processing unit configured to detect an event that requires a change in an operation status of the electronic device and to change an operation status of the electronic device using power of the second battery instead of using the first battery, in response to detecting the event.
